(19) United States
(12) Patent Application Publication
(10) Pub. No.: US 2010/0284735 A1
(43) Pub. Date: Nov. 11, 2010

(54) CONNECTING ELEMENT FOR SNAP CONNECTIONS

(75) Inventors: Eckart Sievers, Frechen (DE); Nadja Michel, Koln (DE)

Correspondence Address: FRASER CLEMENS MARTIN & MILLER LLC, 28366 KENSINGTON LANE, PERRYSBURG, OH, 43551, US

(73) Assignee: Visteon Global Technologies, Inc., Van Buren Twp., MI (US)

(21) Appl. No.: 12/769,765

(22) Filed: Apr. 29, 2010

(30) Foreign Application Priority Data
May 7, 2009 (DE) 102009002917.6

(51) Int. Cl. F16C 11/12

(52) U.S. Cl. 403/291

(57) ABSTRACT

Pairs of corresponding connecting elements for connecting two components at a predefined joining direction by a catch connection fixedly attached to the components to be joined, such that one of the connecting elements has a structure suitable for engaging behind the catch face and the catch face behind which the structure is to engage is situated on the other element of the corresponding connecting elements. At least one of the two connecting elements has a ramp-shaped structure with which the respective other connecting element is in contact during the joining movement and which ensures an elastic deformation as the deflection in preparation for the locking engagement of at least one of the connecting elements during the joining movement, such that the catch face behind which the structure is to engage is situated behind the ramp-shaped structure in the joining direction.

### CROSS-REFERENCE TO RELATED APPLICATION

This application claims priority to German Patent Application No. DE 10 2009 002 917.6 filed May 7, 2009, the entire disclosure of which is hereby incorporated herein by reference.

### FIELD OF THE INVENTION

The invention relates to pairs of corresponding connecting elements for connecting two components in a predefined joining direction. They are provided for a snap connection, which can be produced by simply joining the components to be connected without the help of locking tools. These are provided for a snap connection of plastic housing parts in particular.

### BACKGROUND OF THE INVENTION

Snap connections for plastic components are known in a variety of embodiments and variants. A wide variety of designs are used in the automotive industry in the areas of heating and air conditioning equipment. The principle of conventional snap connections is usually based on the fact that connecting elements which are connected to the components and/or are separate from them are deflected and/or deformed against an elastic restoring force during the joining of the components to be connected before they are at least partially repositioned in an end position of the components to be connected, so that they enter a position in which they are in form-fitting engagement with one another.

It is known that housing parts may be joined together by bringing the separate catch and/or holding elements having catch faces suitably prepared in the housing parts into engagement (DE 38 29 525 A1). However, separate catch elements have the disadvantage that they almost always require a separate assembly step for each catch element for correct placement and/or to establish the desired connection. The number of individual parts required in assembly of the housing determines the complexity of the technological processes in a manner that is a disadvantage. The risk of delays and/or an increased expenditure for the required acquisition of replacement parts may also entail the risk of loss of individual catch elements. The use of separate catch elements in the form of available standard components may also necessitate a separation of materials if the respective housing is to be recycled after use, because in the case of standard component parts, it is usually impossible to ensure the identity of materials between the housing parts and the catch elements that are used.

The disadvantages addressed here are usually bypassed by connecting the required fastening elements and/or catch elements fixedly to the housing parts to be joined. This eliminates the need for separate positioning and there is also no longer a risk of loss. As a rule, such fastening means, which are fixedly connected to the corresponding housing parts, are made of the same material as the housing parts themselves. Various approaches have become known for joining housing parts together with locking engagement without the use of separate fastening means.

It is known that contact may be established between the housing parts to be joined via closed marginal figures, which are made to coincide in the case of a connection and are designed as a tongue and a corresponding groove (DE 94 20 291 U1). However, highly complex and therefore expensive molds are required in order to implement a locking tongue-and-groove connection on injection-molded parts, because this necessitates an undercut, which is also associated with forced unmolding. If a wick effect and/or clearance of the connection are also to be achieved at the same time, narrow manufacturing tolerances must be maintained, which thus limits the lifetime of the tools used in particular and may necessitate their premature replacement. In the case of peripheral profiles in tongue-and-groove form, high joining forces are also necessary to connect the individual housing parts, but these forces can usually be applied during assembly only with the help of a chucking tool specifically designed for this purpose.

It is also known that snap elements and/or catch elements which are fixedly connected to the housing parts to be joined may be provided in discrete positions. For example, it is customary to design snap connections and the respective catch protrusions as integrated construction elements of plastic housing parts. As a result, the molding elements for the snap and catch elements must be integrated into the main molds for the plastic housing parts. For cost reasons, an attempt is usually made here to implement the snap elements in a main direction of unmolding, so that no additional slides or inserts in the mold are required. However, this often results in sharp edges on individual construction elements in the area of mold separations, which are unavoidable from the standpoint of the design. With large molds in particular, this often results in the formation of burrs on such edges, which may be further exacerbated due to wear, the longer the mold is in operation. In the interest of a long lifetime of expensive molds, such burrs should be as tolerable as possible. This necessarily requires dimensioning of the connecting elements, which will ensure that the intended engagement of the corresponding snap and catch elements is not prevented or made difficult by such a burr.

To guarantee a robust and reliable snapping of hooks and noses during assembly of the housing in production and to prevent the hooks from becoming stuck on the aforementioned burrs, which would therefore prevent them from engaging properly, such snap connections are to be designed with a sufficient free movement between the hook and the nose. This free movement must also be ensured on the snap elements, taking into account manufacturing tolerances. However, in the locked state, this may lead to a permanent play between the contact faces of the snap and catch elements. However, this play between the contact faces of the snap and catch elements may under some circumstances cause inadequate fixation of the position of the housing parts thereby joined, from which it follows that the housing components to be joined can be displaced by the amount of this play relative to one another in the snapping direction. Such play cannot be tolerated if the freedom of the finally assembled housing is to be ensured at the same time via the connecting elements. Furthermore, accurate guidance of the components with the help of connecting elements dimensioned in this way is impossible. This play has a great advantage in particular in the case of housings, which assume air guidance functions, for example, and therefore must meet certain requirements with respect to being airtight. This is true to a particular extent for applications in the automotive field, where a very high vibrational load must be expected. Such a design also results in problems, especially against the background of achieving the lowest possible noise emissions.

It is also known that snap and/or catch elements which are to be attached fixedly to the housing parts to be joined are to be provided, where one of the elements, i.e., a hook or a nose, is designed to be so elastic as a result of its shaping that a prestressing force is exerted on the housing components in the direction of joining in the engaged state, causing them to contract and thereby avoid the problems described above. This prestressing force is implemented by a permanent elastic deformation which must occur with the locking engagement. However, the forces to be applied for this deformation increase the mechanical resistance to the joining movement required for the engagement. Therefore, such an approach has two important disadvantages. First, simply bringing the housing components together is not usually sufficient to cause the snap connections to lock into position. Instead of that, it is necessary to induce each individual engagement with a corresponding targeted joining force under some circumstances, to apply the prestressing force and also to ensure secure engagement of the corresponding catch elements. In the case of large and complex housing parts with a relatively large number of joining sites, a special joining device is required for this, but this increases the effort and cost. Secondly, the possible tension force between the housing components is limited by the prestressing force of the elastic elements because relatively small areas of material are included in the deformation. Depending on the profile of requirements and taking into account certain specifications with regard to the choice of materials, structural specifications and manufacturing options, this may result in the required prestressing force no longer being achievable or being achievable only through inappropriate complex design modifications of the fastening means.

### SUMMARY OF THE INVENTION

An object of the present invention is to make available a simple snap connection, which can be manufactured without additional effort in an injection mold and which allows reliable engagement, taking into account the manufacturing tolerance and the possible formation of burrs, without having to accept the disadvantages of play between the components to be joined or the need for a joining device as described above. The snap connection therefore produced should be suitable for use for housing parts in the automotive field in particular.

This object is achieved by pairs of coordinated corresponding connecting elements for connecting two components and a predefined direction of joining, one of which is fixedly joined to one of the components to be joined. This yields a largely predetermined relationship of the positions of the connecting elements to one another when the components to be joined are brought into a defined starting position. Displacement of the components to be joined toward one another in the direction of joining or away from one another thus produces a congruent displacement of the connecting elements in the form of a forced movement, which is a prerequisite for production of a catch connection without the use of auxiliary means because additional measures for arranging or guiding the connecting elements may be omitted if the components to be joined are themselves adequately aligned and accurately guided.

The restoring forces required to establish a catch connection are applied by elastic deformation of at least one of the pairs of corresponding connecting elements during the joining step. The pairs of corresponding connecting elements are designed so that one of the connecting elements has a structure suitable for engaging behind a catch face, such that the catch face behind which the element is to reach is situated on the other of the corresponding connecting elements. At least one of the two connecting elements also has a ramp-shaped structure with which the other connecting element is in contact during the joining movement and which ensures a more or less marked elastic deformation of at least one of the connecting elements, depending on the position of the components to be joined, before this deformation is followed by a partial relaxation of the deformed connecting element when the catch connection is achieved. Due to the alignment of this ramp-shaped structure with respect to the joining direction, a slope may be defined, and this in turn is a partial determining factor for the joining forces to be applied.

The design of the structure suitable for engaging behind a catch face, and the design of the catch face behind which it is to engage have proven to be the construction detail providing favorable results to the present invention. There is a predominantly form-fitting contact between the two, thereby implementing the retaining function of the catch connection. However, the alignment of the surfaces that are definitive for the form-fitting connection is such that at least one of these surfaces is inclined with respect to the deflection direction due to the elastic deformation during the joining step, i.e., it does not run parallel or tangentially to this deflection direction. The inclination mentioned here is also selected so that the inclined face manifests the effect of a ramp when the corresponding connecting elements snap into the locked position. In locking, the corresponding contact face slides up on this ramp until reaching a final position. The engagement thus leads to a certain end position, at least for one of the connecting elements, which is established by self-adjustment. However, this certain end position, although not defined by stops or similar design measures, ensures an increased tolerance with respect to deviations in dimension and/or position of the connecting elements in the direction of joining, while maintaining a fastening and holding effect that is always uniform. Furthermore, the utilization of the ramp effect of the catch face in engagement always results in a permanent tensile force in the joining direction, so that freedom from play between the components to be joined can easily be implemented in this direction. To this end, the alignment of this ramp, which at the same time serves as a catch face, may therefore take place in such a way that it is aligned at an inclination to the main joining direction but not perpendicular thereto, for example.

A minimal configuration of the invention comprises pairs of corresponding connecting elements for connecting two components at a predefined joining direction by using a catch connection, each being fixedly joined to the components to be joined, such that one of the connecting elements has a structure suitable for engaging behind a catch face, the catch face behind which the element is to engage is situated on the other of the corresponding connecting elements, at least one of the two connecting elements has a ramp-shaped structure with which the other respective connecting element is in contact during the joining movement and which ensures an elastic deformation as the deflection preparing for the locking engagement of at least one of the connecting elements during the joining movement, such that the catch face behind which the other element is to engage is situated behind the ramp-shaped structure in the joining direction such that the catch face is inclined with respect to the direction of deflection of the elastic connecting elements, so that it always forms an inclined plane in the locking engagement in the contact area of the connecting elements, with the catch movement being opposite the slope thereof.

The present invention thus consists in general of a design of corresponding catch elements and/or connecting elements, which combine a primarily form-fitting connection in the engaged state with a locking component, which is achieved by the frictional effect of contact faces of the catch elements and/or connecting elements inclined with respect to the main direction of joining as well as with respect to the direction of deflection of the catch movement and being in contact with one another. The friction effect of contact of the contact faces is advantageously supported by an elastic restoring force of at least one of the corresponding catch elements and/or connecting elements.

The present invention combines the advantages of a simple catch connection with those of a screw connection and/or a connection using other tension elements. Since all catch elements and/or connecting elements are an integral part of the components to be joined, no separate components are required, so this results in cost advantages in production due to the savings of additional components as well as due to the elimination of additional assembly steps during the joining operation. The self-adjusting equalization of tolerance allows the production of a joint without play which would otherwise be possible only with screws or other tension elements without making increased tolerance demands of the catch elements and/or connecting elements. Merely connecting the housing parts to be joined yields reliable catch engagement of the catch elements and/or connecting elements without requiring further operations or controls of the connection. The required joining force can be minimized in relation to the achievable strength. Avoiding the use of standard connecting elements simplifies the separation of materials into pure types at the end of their lifetime.

It has proven to be advantageous when the ramp-shaped structure and the catch face behind which the element is to engage are situated on a connecting element, which is rigidly attached to a component to be joined, and the structure suitable for engaging behind the catch face is provided on a connecting element which can be attached in an elastically deflectable manner to another component.

It is advantageous in particular if the inclination of the catch face is selected so that in the case of a load on the connection, the angle of friction in the contact area of the connecting elements is not exceeded.

### BRIEF DESCRIPTION OF THE DRAWINGS

The invention is explained in greater detail below on the basis of an exemplary embodiment with reference to the drawings, in which:

FIGS. 1A-C show a simplified diagram to illustrate the inventive joining principle;

FIG. 2 shows an exemplary diagram of a pair of corresponding connecting elements in the form of a catch nose and strap-shaped snap hook;

FIG. 3 shows an exemplary embodiment of the catch face of a catch nose with a burr running on it;

FIG. 4 shows the inventive connecting element embedded in a connecting system with an end stop and a positioning aid;

FIG. 5 shows an exemplary two-part plastic housing having the inventive connecting elements.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

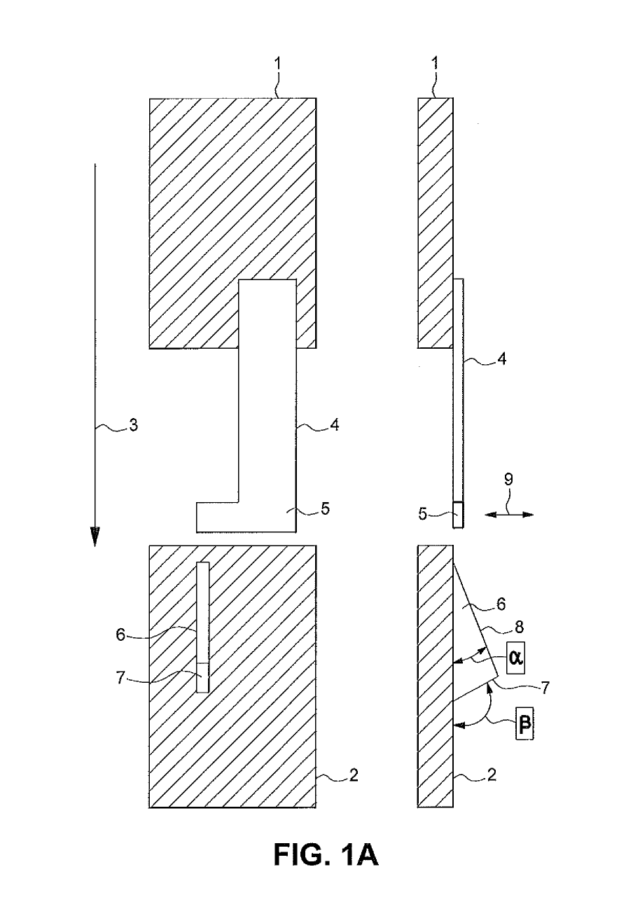

FIG. 1A shows a simplified diagram of the fundamental geometric relationships to illustrate the inventive joining principle. Two wall areas of plastic housing parts 1, 2 of a heating and air conditioning system for motor vehicles are shown here in detail, wherein these wall areas are to be joined together. Pairs of coordinated and corresponding connecting elements 4, 6 for connecting the two housing parts 1, 2 are provided on these housing parts 1, 2, such that one of the connecting elements 4, 6 is fixedly attached to each of the housing parts 1,2 to be joined. The two housing parts 1, 2 are connected in a predefined joining direction 3. One of the connecting elements 4, namely on the upper housing part 1 here, has a structure suitable for engaging behind a catch face 7, which is in the form of an elastically deflectable hook or an engaging structure 5 in the present case. The other one of the corresponding connecting elements 6, shown here on the bottom housing part 2, has a catch face 7, behind which the other element 4 engages. This also has a ramp-shaped structure 8, which is characterized by the angle α and on which the elastically deflectable hook 5 is in contact during the joining movement and ensures a more or less marked elastic deformation of the hook 5, depending on the position of the housing parts 1, 2 to be joined before this deformation is followed by a partial relaxation of the deformed hook 5, when the catch connection is created after reaching the end position of the housing parts 1, 2 to be joined. A slope which also determines the joining forces to be applied is defined by the orientation of this ramp-shaped structure 8 with respect to the joining direction 3, as characterized by angle α. The catch face 7 behind which the other element 4 engages is oriented in the present case so that it is inclined with respect to the main joining direction 3, but is not aligned perpendicular to it. It forms the obtuse angle β to the housing 2 wall, which runs here in the joining direction 3. The catch face 7 is also aligned so that it is slightly inclined with respect to the deflection direction 9 of the elastic hook 5 in such a manner that a face of the hook 5 which is involved in the contact for the desired form-fitting connection runs onto catch face 7 under increasing force-locking engagement during the locking engagement. Due to such an orientation of the catch face 7, the latter also manifests the effect of a ramp during the actual locking engagement, thus ensuring a tension acting on the housing parts 1, 2 that are to be joined, pressing them toward one another in the engaged state. This effect is always achieved when the other element engages behind the catch face 7. However, complete relaxation of the elastically deflected hook 5 is not important here. This yields a great tolerance with respect to deviations in dimension without interfering with the function of the snap connection.

The two exemplary embodiments illustrate two extreme positions in which the connecting effect is fully maintained. FIG. 1B shows the case in which almost complete relaxation of the elastically deformed hook 5 has occurred. An elastically deformed gasket 10 is shown between the two housing parts 1, 2, preventing the housing parts 1, 2 from approaching one another further. In this case, the force-locking connection between the catch face 7 behind which the other element 4 engages and the structure 5 engaging behind the catch face 7 would be disturbed.

To illustrate the problem with tolerance and dimensional stability, FIG. 1C shows a rigid foreign body 11, which prevents the distance between housing parts 1, 2 from being further reduced. However, the functionality of the snap connection is retained even in this case because the elastically deflectable hook 5 engages at least partially behind the catch face 7. There remains a definite residual deformation of the hook 5 and/or of the connecting element 4, which is associated with a permanently applied restoring force acting in the catch deflection direction 9, and in this case has an advantageous stabilizing effect. FIGS. 1B and 1C thus illustrate the principle of a self-adjusting catch connection having dimensional tolerance.

The stability of the inventive catch connection also depends substantially on the extent to which it is possible to prevent parasitic deformation of the connecting elements 4, 6 involved. Parasitic deformation is understood to refer to any unwanted deformation which leads to an impairment in or loss of the functionality of the connecting elements. The following exemplary embodiment shows an especially robust design of an inventive snap connection in this regard.

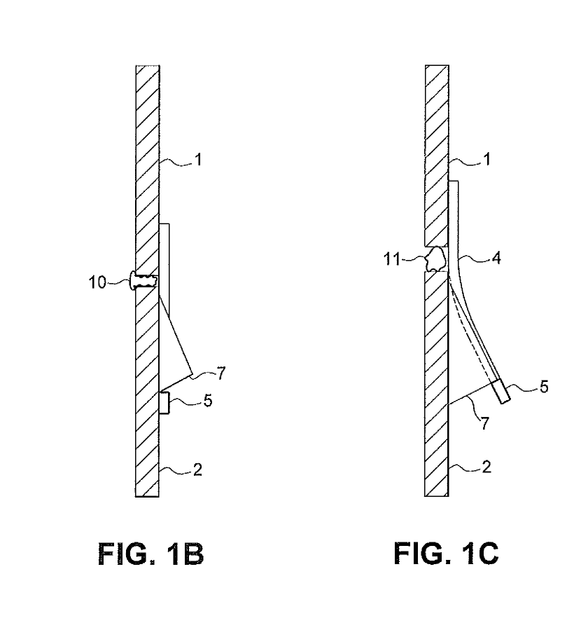

FIG. 2 shows an exemplary embodiment of a pair of corresponding connecting elements in the form of a catch nose 12 and a strap-shaped snap hook, also known as a snap strap 13. The snap strap 13 is guided along a run-up ramp 8 of the catch nose 12 in connecting the housing components 1, 2, and in doing so is deflected almost at a right angle to the joining direction, to then snap back onto the catch nose 12 after reaching a maximum deflection along the actual catch face 7, thereby establishing a form-fitting connection between the strap 13 and the nose 12. This special stability is derived from the fact that the part of the catch strap 13 which is supported with respect to the catch face 7 of the catch nose 12 is supported on both sides of an engaging structure, a hook, or a contact area 14, which follows from the strap 13 shape, therefore largely preventing unwanted deformation. The contact area 14, which is provided for engaging behind the catch face 7, is thus also a part of a snap strap 13 through which a catch nose 12 protrudes with the corresponding catch face 7 in the locked state.

The desired freedom from play is achieved by means of a special shaping of the catch face 7 on the catch nose 12 as in example 1 of FIGS. 1A-1C. This represents an inclined plane in relation to the deflection line of the snap strap 13, on which the strap 13 slides upward when snapped back. How far the strap 13 can spring back in this process will depend on the respective tolerance conditions of the snap strap 13 and the catch nose 12. Since the contact area 14 of the snap strap 13 required to establish the snap connection travels along a curved path during the deflection, the catch face 7 has also been designed with a curved shape accordingly in an advantageous manner. Therefore, during the locking engagement, the contact area 14 of the snap strap 13 is guided in the direction opposite the slope, which is largely independent of the degree of remaining deflection of the snap strap 13 in the final position reached, i.e., when the snap connection has been fully established. The inclined plane which becomes effective here is thus characterized by the tangent to the curved catch face 7 in the respective contact area between the catch face 7 and the snap strap 13.

The inclination and the position of the inclined plane and/or the curvature of the curved catch face 7 relative to the deflection curve of the contact area 14 of the snap strap 13 may advantageously be selected so that the strap 13 can snap back to the middle of the catch face 7 with nominal dimensions of the snap strap 13 and the catch nose 12. This yields a maximum tolerance with respect to randomly occurring deviations in dimension. In other words, this means that at the maximum material condition (strap 13 at the lower tolerance limit, nose 12 at the upper tolerance limit), the contact area 14 of the strap 13 is positioned at the beginning of the catch face 7 which is still able to reliably engage, and at a minimal material condition (strap 13 at the upper tolerance limit, nose 12 at the lower tolerance limit), the strap 13 becomes engaged at the upper end of the catch face 7 (near the housing) but is still slightly prestressed in comparison with its design position.

It is especially advantageous if the orientation and/or curvature of the catch face 7 is/are such that the angle of the effective inclined plane in the contact area between the snap strap 13 and the catch face 7 is always smaller than the material-specific angle of friction in relation to a tensile force that would occur on the snap strap 13 during separation of the joined housing parts 1, 2. In this way, the slippage of the strap 13 on the catch nose 12 can be reliably prevented when a load is applied to the snap connection in the joining direction or opposite the joining direction. In this case, the strength of the catch connection is independent of the elastic restoring force of the catch strap 13. Failure of the snap connection is then possible only due to mechanical overloading of the strap 13 and/or the catch nose 12, which is taken into account by corresponding dimensioning.

When the housing components 1, 2 are completely joined and the snap strap 13 is fully deflected, there is always enough play between the contact faces of the snap strap 13 and the catch face 7, so an independent robust and secure snap connection of the snap strap 13 is ensured without having to press the strap 13 into its intended final position by a separate operation or joining device. On the other hand, freedom from play between the joined housing parts 1, 2 is ensured by the fact that the snap strap 13 recoils back into its original position after being snapped until it comes into contact with the catch face 7 on the catch nose 12 and is pressed tightly against it, thus establishing a connection between the housing parts 1, 2 that is free of play.

In particular, when a spring force of the snap strap 13 acts at a right angle to the loading direction of the catch connection, the connection strength is independent of the restoring force of the snap strap 13 and depends only on the mechanical strength of the snap strap 13 and the catch nose 12 in the loading direction. On the basis of a sufficiently shallow angle of inclination between the catch face 7, the catch nose 12, and the curved deflection figure of the snap strap 13, i.e., in particular taking into account the angle of friction, there is a self-inhibition of the connecting system, which makes unintentional release of the connection impossible, even under a high load. The remaining restoring force of the snap strap 13 also ensures a high vibration tolerance of the connection, which is an additional advantage in automotive engineering in particular.

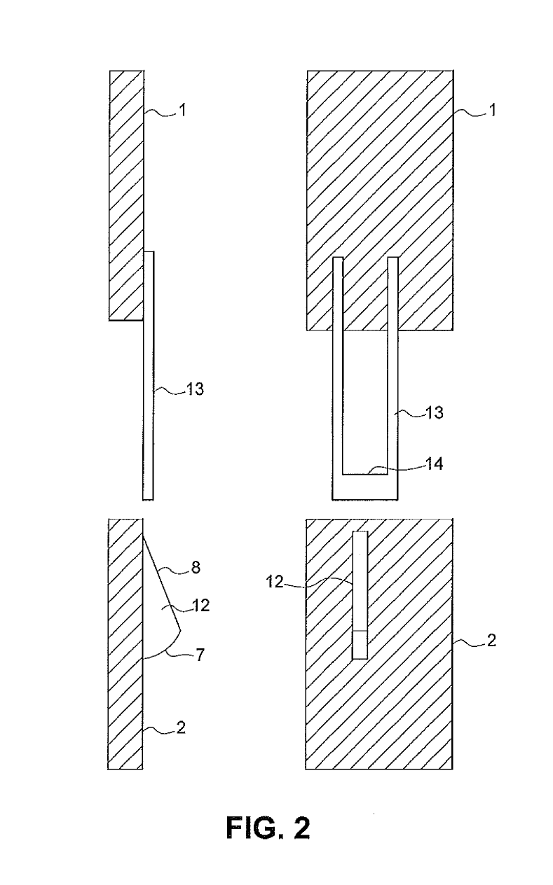

The high tolerance with respect to deviations in dimensions additionally makes it possible to utilize in a targeted manner the occurrence of technologically induced burrs formed on the parts to further increase the reliability of the connection. A burr 15 on the catch face 7, running parallel to the joining direction or catch direction, as shown in FIG. 3, is exposed to a high pressure in establishing the catch connection and ultimately has a notched-shaped indentation or a true notch. Due to the resulting micro-form-fitting connection, subsequent deflection of the snap strap 13 is additionally impeded. The effect of such a burr 15 thus corresponds to an effective influence on the angle of friction between the catch face 7 and the snap strap 13. Development of such a burr therefore does not have a negative effect on the inventive function principle as long as it does not prevent the catch connection from becoming established in general.

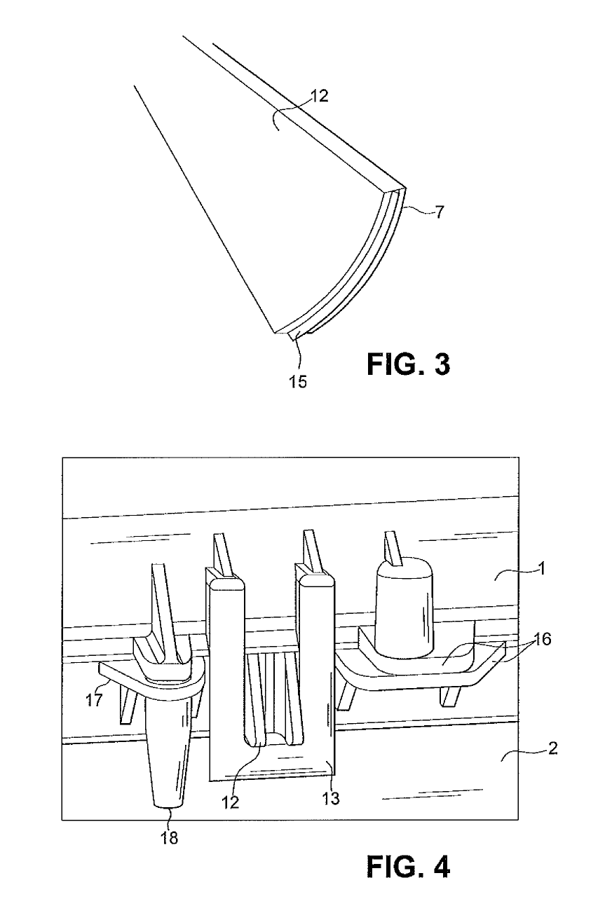

FIG. 4 shows an especially advantageous design for embedding the inventive connecting elements 12, 13 in a connecting system with an end stop and with a positioning aid in immediate proximity to the connecting elements 12, 13. The housing parts 1, 2 to be joined have corresponding supporting structures 16 with stop faces, which determine the end position of the housing parts 1, 2 to be joined in the joining direction. In addition, corresponding positioning aids in the form of an eye 17 and a conical plug 18 are fixedly joined to the housing parts 1,2, thus ensuring a correct orientation of the housing parts 1, 2 in the plane perpendicular to the joining direction and ensures reliable establishment of the inventive catch connection.

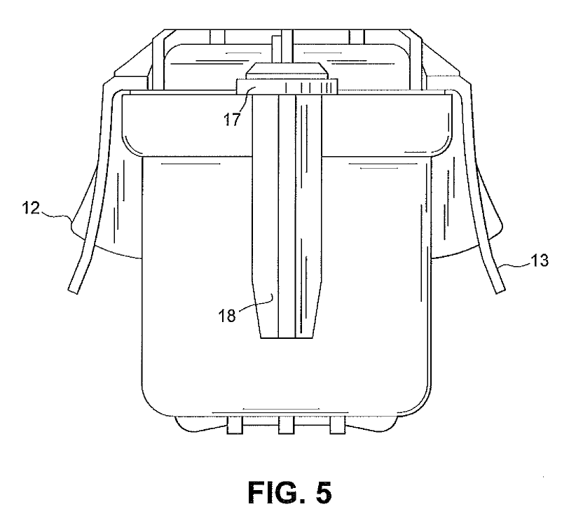

FIG. 5 shows an example of a two-part plastic housing having inventive connecting elements in the form of snap straps 13 and catch noses 12. The housing parts are manufactured as injection molded parts including the connecting elements 12, 13 attached to them. The snap straps 13 are in a middle deflection position, as this is provided with good dimensional stability of the connected housing parts. The design of the molds in particular is such that the arrangement and inclination and/or curvature of the catch face 7 is selected so that with nominal dimensions of the components to be joined, including the connecting elements 12, 13, there is a catch engagement up to the center of the catch face 7. A pair of corresponding positioning aids 17, 18 as mentioned above is visible on the front side of the housing.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A catch connection for connecting a first component to a second component in a predefined joining direction comprising:
a first connecting element fixedly attached to the first component, the first connecting element including an engaging structure formed thereon; and
a second connecting element fixedly attached to the second component, the second connecting element including a ramp-shaped structure and a catch face, the ramp-shaped structure deforming the first connecting element during a joining movement in a joining direction between the first component and the second component, wherein the engaging structure of the first connecting element engages the catch face of the second connecting element to connect the first component to the second component; and wherein the catch face is inclined in respect of the joining direction.

2. The catch connection according to claim 1, wherein the first connecting element is elastically deflectable.

3. The catch connection according to claim 1, wherein the catch face is inclined at an angle which does not exceed an angle of friction between the catch face and the engaging structure.

4. The catch connection according to claim 1, wherein the catch face has a convex surface.

5. The catch connection according to claim 1, wherein a burr is formed on the catch face parallel to the joining direction.

6. The catch connection according to claim 1, wherein the first connecting element is a snap strap and the second connecting element is a catch nose, wherein the snap strap is adapted to receive the catch nose therein.

7. The catch connection according to claim 1, further comprising positioning aids arranged on the first component and the second component.

8. The catch connection according to claim 1, wherein the first connecting element is a hook.

9. A catch connection for connecting a first component to a second component in a predefined joining direction comprising:
a first connecting element fixedly attached to the first component, the first connecting element including an engaging structure formed thereon, wherein the first connecting element is elastically deflectable in a deflection direction; and
a second connecting element fixedly attached to the second component, the second connecting element including a ramp-shaped structure and a catch face, the ramp-shaped structure deflecting the first connecting element in the deflection direction during a joining movement in a joining direction between the first component and the second component, wherein the engaging structure of the first connecting element lockingly engages the catch face of the second connecting element to connect the first component to the second component; and wherein the catch face is inclined in respect of the ramp-shaped structure and the joining direction.

10. The catch connection according to claim 9, wherein the catch face is inclined at an angle which does not exceed an angle of friction between the catch face and the engaging structure.

11. The catch connection according to claim 9, wherein the catch face has a convex surface.

12. The catch connection according to claim 9, wherein a burr is formed on the catch face parallel to the joining direction.

13. The catch connection according to claim 9, wherein the first connecting element is a snap strap and the second connecting element is a catch nose, wherein the snap strap is adapted to receive the catch nose therein.

14. The catch connection according to claim 9, further comprising positioning aids arranged on the first component and the second component.

15. The catch connection according to claim 9, wherein the first connecting element is a hook.

16. A catch connection for connecting a first component to a second component in a predefined joining direction comprising:
a first connecting element fixedly attached to the first component, the first connecting element including an engaging structure formed thereon, wherein the first connecting element is elastically deflectable in a deflection direction; and
a second connecting element fixedly attached to the second component, the second connecting element including a ramp-shaped structure and a catch face, the ramp-shaped structure deflecting the first connecting element in the deflection direction during a joining movement in a joining direction between the first component and the second component, wherein the engaging structure of the first connecting element lockingly engages the catch face of the second connecting element to connect the first component to the second component; and wherein the ramp-shaped structure is disposed at an angle α in respect of the joining direction and the catch face is disposed at an angle β in respect of the joining direction.

17. The catch connection according to claim 16, wherein the first connecting element is a snap strap and the second connecting element is a catch nose, wherein the snap strap is adapted to receive the catch nose therein.

18. The catch connection according to claim 16, further comprising positioning aids arranged on the first component and the second component.

19. The catch connection according to claim 16, wherein the first connecting element is a hook.

20. The catch connection according to claim 16, wherein the angle β is greater than the angle α.
